(19) United States
(12) Patent Application Publication
(10) Pub. No.: US 2023/0419340 A1
(43) Pub. Date: Dec. 28, 2023

(54) VIRTUAL-REALITY ENVIRONMENT AND ASSOCIATED METHODS OF SALES, DATA CRAWLING AND MARKETING THEREOF

(71) Applicant: Drink Holdings, Inc., Glendale, CA (US)

(72) Inventors: Zac Brandenberg, Glendale, CA (US); Barry Collier, Glendale, CA (US)

(21) Appl. No.: 17/850,728

(22) Filed: Jun. 27, 2022

(51) Int. Cl. G06Q 30/0201; G06Q 10/087

(52) U.S. Cl. CPC G06Q 30/0201; G06Q 10/087; H04L 67/12

(57) ABSTRACT

The present invention relates to a new artificial intelligence, operating for example on a virtual-reality system with AI for use in VR environment and associated methods of sales, data crawling and marketing thereof. More specifically, a VR-implemented system designed to improve effective sales, data crawling and marketing performances by optimizing a descriptor-based system via an heightened descriptor set. The artificial intelligence is built on the segmentation of products or services in a set of descriptors of multiple types. Creating a mask that selects a portion or all of these basic descriptors, a heightened descriptor (HD) is generated for each of the set of products or services. Using multiple HDs for all given products or services, a genetic map of the products is enhanced and the artificial intelligence is able to leverage these HDs for the implementation of marketing, sales or even data crawling tools that enhance sales, create a system that teaches a computer to “perceive” products or services and enter into the analysis elements of human subjectivity or human/societal emotions to help pair and match sales with buyers. The AI system, as most AIs is adaptive but with a key difference in that it grows the field of descriptors to correct any mistake and learn instead of simply altering different programmed ranges.

### FIELD OF THE INVENTION

The present invention relates to a new artificial intelligence, operating for example on a virtual-reality system with AI for use in VR environment and associated methods of sales, data crawling and marketing thereof. More specifically, a VR-implemented system designed to improve effective sales, data crawling and marketing performances by optimizing a descriptor-based system via an heightened descriptor set.

### BACKGROUND OF THE INVENTION

Marketing, data crawling and sales techniques vary greatly in each field or industry. Optimal sales and marketing processes and systems are often field specific and leverage the numerous unique features of any given field/industry. Cars are sold using different methods as apparels which in turn are sold differently than most other products or serves. As every marketing expert would insist, to improve sales, data crawling, or marketing efforts, unique methods and systems must be put in place and such systems vary greatly in each field. The notion that sales and marketing methods used in one industry simply translate to a different industry are, to put it mildly, misleading and optimistic. In the car industry, to enhance the point-of-sale experience for new products, trademarked and patented fragrances can be sprayed into the product. A potential buyer will open the door and subconsciously, the “fresh car smell” will aid in selection of a product. Such a unique tools, for example, would not translate if a car is purchased online or when apparels are sold.

A key feature of non fully-digital sales is often the presence of an experienced sales agent able to read the body language, cues, and emotions of a potential purchaser and such information can organically be incorporated as part of the sales process. This feedback is useful and valuable but has yet to translate efficiently into non-personal sales techniques. As everyone knows, such skills and cues are very difficult to quantify and master. The agent, often intuitively and subconsciously, can see an arriving customer, watch the dynamic with products in shelves (internal) or even draw conclusions from the clothing worn by the customer (external).

In the car industry, a person may drive to the dealership with one model of observable car (external) and park such car in a unique fashion (internal). If the car is the dealership's own brand, this would suggest a satisfied and experienced customer with the brand and this in turn would alter the sales effort. Such ‘unspoken’ truths and guides are extremely hard to quantify and use as part of sales and even more so as part of an automation process. An artificial intelligence able to assist in any sales process, able to leverage these unspoken truths is highly desirable but also extremely difficult to implement in a broad multi-field approach. The invention below solves these problems elegantly and organically.

Furthermore, in the field of shelved consumer products, such as a bottle of wine, a customer walking in a store may naturally be drawn to certain areas of displays. In many stores, depending on the volume and quantity of wines, these can first be indexed by country of production (e.g. France, Italy, Chile). Also wines can be indexed as to colors (e.g. rose, red, white, orange). In the case of wine, unlike the above example, a sales person is less likely to be able to pick up visual cues and will need to engage with customers on a deeper level. A tool able to leverage unspoken truths in the context of any given sale is even more desirable and needed to help the process of marketing of such products is highly desirable.

The above does not only relate to ‘goods’ or ‘products’ but equally applies to services or semi-services where goods are use in conduction with an offered service. In the field of exercises, often seen mostly as gym coaching services, a customer will walk into a location and gravitate naturally to some equipment or some of the pictures on the wall of coaches. A customer may prefer one gender over the other for private coaching sessions and a person's bodyweight often is an indication of the anticipated type of services expected (e.g. weight loss, maintenance, or performance). All three above “personal” sales experiences also require from the sales representative a very good level of expertise in the product/service offered and some skills in reading customers. Here again, any artificial intelligence tool designed to help with the sale of services to customers is highly desirable.

Also, it is important to note that in and around 1994, with the growth of computer technology and the internet, customers began to feel more comfortable with the notion of buying goods online or using computer terminals at the point of sale for guidance or help. Payment systems evolved to help with selection processes and checkout process. Indexing systems, when large amount of products exist improved but the use of menus to navigate remain very painful and disfavored by buyers. For example, most people prefer to walk a caddie down a physical aisle and visually and manually inspect products in association with grocery shopping. In 2020, the Covid-19 pandemic hit and forced consumers away from brick & mortar stores and toward online purchases even of goods or products historically disfavored from online purchase. Some apparels like gloves must be slipped on before a purchase is made. At the moment, many corporations must rely on the notion of “free returns” to help customers feel confident with the selection decision of products or services they would rather buy live. The use of artificial intelligences to help guide and navigate difficult purchases is highly desirable.

Systems and methods which results in improved sales outputs (i.e. greater sales for the same effort) and limit the number of returns are useful and greatly desired. The current invention's purpose is to help improve the overall sales experience, the marketing experience and match better products with customers resulting in increased output of any sales system. One of the most complex and subjective field of marketing, sales and purchase is to the inventors wine, alcohol and other spirits. Wine tastes are very subjective, thousands of products are offered, purchasing decisions are rapid, instinctual, and more importantly while a person may prefer one wine, it is customary to ‘butterfly’ in purchasing from one product to the next. Also, since the products are offered in a wide cost range (e.g. $10 to $200 per bottle), decisions are notoriously difficult to manage as some are personal, other gifts, etc. In contrast, a handful of laundry detergents exist and often customers are loyal to one brand over the other. In the field of wine, while customers may be loyal a winery, it is customary to vary purchases over time the same way individuals change in the selection of restaurants and meals.

Wine labels are also hard to memorize by customers. Products are gifted during a visit without and packaging and the overall appearance of a product is often a key as part of the decision to purchase. Historically wine is often gifted and consumed on the same day inserting itself as an immediate part of any experience. In contrast, the gifting of apparels is completely different.

To help guide consumers in the purchase of wine, cars, services or other consumer products, several systems and methods exist and fight for efficiency and performance. Experts and wine connoisseurs may rank and give opinions about wines which make their way into catalogs and grading systems. Like movie goers trust their favorite critics, some buyers will then flock to advice from their known and recognized expert. One important drawback of relying on such a system is the inherent bias of experts and the complexity of having to search and index a wine each time one is purchased. For example, when standing in front of a large wine display or when surfing to a webpage with hundreds of wine labels, a user simply does not have the bandwidth to use this system and method to select a wine. Online, people can only be given a handful of options limiting greatly the digital buying experience.

In the case of wine expert ratings, there are studies that show that there can actually be a negative correlation between wine expert ratings and general consumer taste preferences, which underlies the fact that the taste of wine is at best very subjective. Even among many wine experts, there can be high variances in ratings for the same wine. This nuance and subjectivity with respect to the taste of wine has led to the development of a number of more advanced approaches for individualizing wine recommendations. These approaches generally start by using various techniques to classify wines. The methods used to classify the taste can range from using an expert panel to designate the intensity levels of each, to using advanced machinery for detailed chemical analysis. A consumer taste profile is then generated using various explicit and implicit feedback techniques.

Consumers subconsciously in some industries use a variety of visual cues to help choose their wines and other products, which include descriptions of the wine's taste, the style of the label, etc. It is these visual cues on the bottle that subconsciously affect how the consumer perceives the wine will taste, and how it will make them feel. Therefore, these visual cues actually play an important role for wine consumers, not only in whether they choose a wine from a larger selection of available wines, but also whether they will actually enjoy the wine.

The current technology relies on multiple fields of research and analysis. Marcia Roosevelt filed in 2001, U.S. patent application Ser. No. 09/782,864, directed to a method of developing a conceptual design for a product or service which involves defining a conceptual design goal and parameter and then creating a project team representing several diverse types of intelligences. Visual help can be used to reinforce selection models. Several years later, Mister James D. Kolsky filed U.S. patent application Ser. No. 10/389,348 directed to a method and apparatus for managing product planning and marketing. This tool, in the field of wine, was designed to describe how using segments of consumers and statistical evaluation of linking indications, some wines can be grouped and thus can be linked to improve consumer association. The problem with these solutions is the need for intense understanding of statistical information, and a deep knowledge of the consumer making a decision. In most cases, consumers simply do not know their own flavor profiles or tastes and cannot give the system any information.

Other methods to classify wine also rely intensively on the characterization of wine and not labeling. For example, inventor Alyssa J. Rapp, in 2009, filed U.S. patent application Ser. No. 12/366,918, titled method and system for classifying and recommending wine. In this system, a database is used where wine is inventoried. The information uploaded for each wine includes a set of attributes, a taxonomic category, a numeric bin value, and then somehow uploading a numeric personal taste profile of a user to help select the wine. Once again, this system is burdensome, data intensive and assumes a user knows its own personal taste profile or that a user has enough wine selection information or patience to populate forms to help determine the profile. Two years later, inventor Michael J. Tompkins filed U.S. patent application Ser. No. 13/627,738 titled systems and methods for wine ranking. The same way, user preferences and intensity values are used to help populate a database filled with descriptors and intensity values linked with each wine. These methods rely on a user's deep understanding of wine, a capacity to relay this information into a system which will help him select.

Sophie Lebrecht, filed U.S. patent application Ser. No. 14/382,406 titled method and system for using neuroscience to predict consumer preference. In this case, images can be presented to an individual in patterns and the calculation of a valence value linked with a paradigm can be designed as a stimuli to enhance experiences. By 2010, Gergely Szolnoki et al. published Origin, Grape Variety or Packaging? Analyzing the Buying Decision for Wine with a Conjoint Experiment. This research from the American Association of Wine Economist (Working Paper No. 72), looked to see what portion of wine branding was instrumental in wine making decisions from different groups such as younger consumers, older wine connoisseurs, or even main stream clients, and it was concluded that label style, like bottle color, bottle form, and identification of the wine was instrumental in a 10% percent of the buying decisions. For a main stream population, the primary vector of purchase was the label style. This report concluded that in up to 70.1% of purchase decisions, the bottle form, the color and the label had the greatest influence in buying and in 39.5% of the time, the label was the primary factor across all purchasing segments.

California Polytechnic State University student Molly Webster, in June 2010, published in partial fulfillment of the requirements for the degree of Bachelor of Science a piece titled, Analysis of Wine Label Design Aesthetics and the Connection to Price. This person analyzed the price of wine, also a 1-100 score for the product as ranked by Mr. Parker, and tried to compare some label design features. The conclusion was that “[w]hile the artistic and design variables of a wine label may persuade a consumer, they do not affect how a wine is originally priced by the manufacturer.”

Moving closer in time, in 2017, Mr. Buldoon filed for a new characterization of liquids in sealed containers in Europe and in the United States, this patent was granted in the United States as U.S. Pat. No. 10,705,017. This technology, shown at FIG. 1 illustrates how a beam of light is shone on a closed bottle and using sensor technology, the light diffusion is read in an effort to find and quantify a molecule present inside the bottle. Such molecule is then used to draw a ‘characteristic’ of the wine based on experience. Such technology, to put it mildly, remains mostly science fiction as the molecular association of wine is mostly inconsequential to wine purchases.

In 2018, Mr. Zac Brandenberg and his co-inventors were precursors in developing and securing rights over an online technology able to create and generate customized marketing pieces over the internet using labels based on user profiles of users paired with database profiles. He secured, along with co-inventors U.S. Pat. No. 11,263,689 directed to a wine label affinity system able to generate customized communications thanks to input from the user for the generation of a personalized email. The same year, inventors Kim and Lee of South Korea referring to Mr. Brandenberg's invention filed and secured U.S. Pat. No. 10,769,703 titled method for providing service of personalized recommendation based on e-mail and apparatus therefor. Shown at FIG. 2 taken from this prior art, an HTML link is sent which relies upon a dynamic image output code which includes an API trigger for execution only once an email is read. The code, allows for subsequent (post communication) calls on API from information content. This allows for the sending of emails at time T and for the update at time T+1 of output dynamic content instead of placing the content in the email or updating an HTML link.

In 2019, a South Korean wine recommendation system and method describes the use what it calls ‘contextual information analysis’ linked with keyword indexing secured either a meeting or a message to be conveyed between two parties as the basis of keyword indexing. This publication is offered as Korean Publication KR102079289. In Jan. 25, 2022, issued U.S. Pat. No. 11,232,498 to assignee Penrose Hill of New York for a method for labeling and distributing products having multiple versions with recipient version correlation on a per user basis. As part of this invention, new labels of wine are designed using a panel template where the label characteristics are simply ratings and quantified attributes such as medals, color, font size. Also anticipated as the panel of characteristics can be the product attributes (e.g. acidity, sugar) instead of visual product label characteristics in contrast to label characteristics. This technology uses Gaussian Mixture Models as a form of machine leaning or something called dynamic time warping alignment calculations with spatial ranking.

The inventors today have discovered that Artificial Intelligence is required to further improve these systems and it is important to leverage more than basic information on a product, a service or simple purchaser preferences. In fact, the inventors have discovered that over time, for any given purchaser, that person's own sensitivities and purchasing profile may evolve greatly. What is required is a system, with Artificial Intelligence which leverages a database of products in a newly and non-obvious way which further enhances the marketing, adverting and sales of products over a digital interface.

### BRIEF SUMMARY OF THE INVENTION

The present invention relates to a new artificial intelligence, operating for example on a virtual-reality system with AI for use in VR environment and associated methods of sales, data crawling and marketing thereof. More specifically, a VR-implemented system designed to improve effective sales, data crawling and marketing performances by optimizing a descriptor-based system via an heightened descriptor set. The artificial intelligence is built on the segmentation of products or services in a set of descriptors of multiple types. Creating a mask that selects a portion or all of these basic descriptors, a heightened descriptor (HD) is generated for each of the set of products or services. Using multiple HDs for all given products or services, a genetic map of the products is enhanced and the artificial intelligence is able to leverage these HDs for the implementation of marketing, sales or even data crawling tools that enhance sales, create a system that teaches a computer to “perceive” products or services and enter into the analysis elements of human subjectivity or human/societal emotions to help pair and match sales with buyers. The AI system, as most AIs is adaptive but with a key difference in that it grows the field of descriptors to correct any mistake and learn instead of simply altering different programmed ranges.

### BRIEF DESCRIPTION OF THE DRAWINGS

FIG. 1 is a first illustration from the prior art.

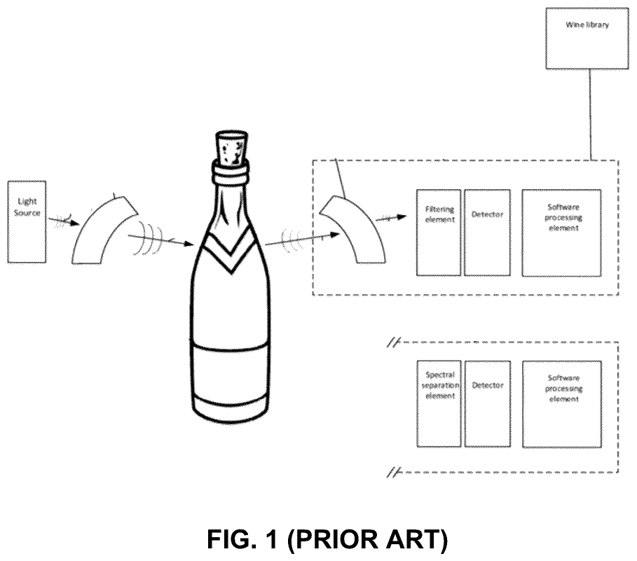

FIG. 2 is a second illustration from the prior art.

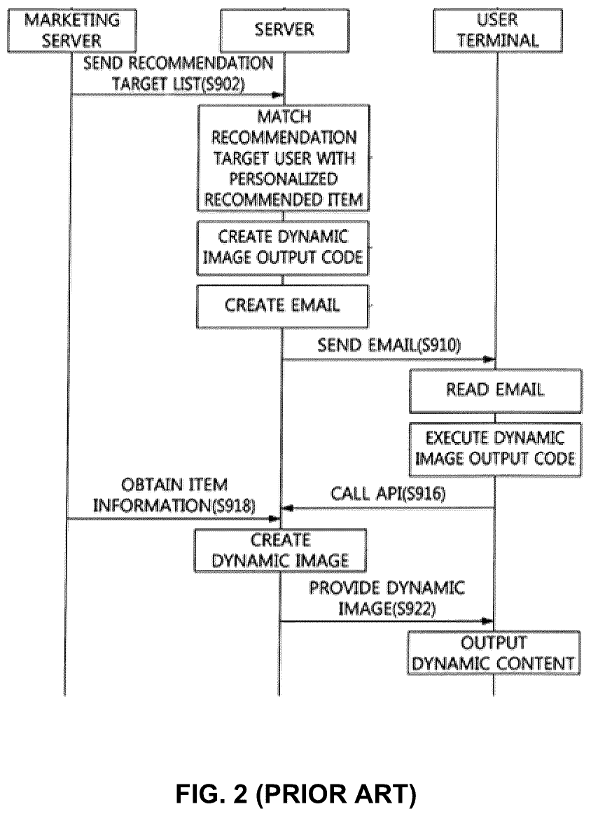

FIG. 3 is a schematic illustration of possible hardware used in a network configuration.

FIG. 4 is a schematic illustration of the different internal software layers needed to process information by the different hardware elements shown at FIG. 3, according to an embodiment of the present invention.

FIG. 5 is a schematic illustration of hardware server structures linked with saving, managing, and transferring information between different hardware components shown at FIG. 3 and operating according to software processes shown at FIG. 4, according to an embodiment of the present invention.

FIG. 6 illustrates possible App or Virtual Reality-based software management between local and remote devices using typical URL, links or other installation of locally executable applications as shown at FIG. 4.

FIG. 7 is a schematic representation of the descriptor-based artificial intelligence for use on computerized affinity systems and associated methods of sales, data crawling and marketing thereof according to one embodiment of the present disclosure.

FIG. 8 is a representation using a spider chart of the respective perception traits of two different labels, according to an embodiment of the present disclosure.

FIG. 9 is a schematic representation of the process for the creation and storage of a mask for an heightened descriptor and the process of updating for outlier by the artificial intelligence shown at FIG. 7, according to an embodiment of the present disclosure.

FIG. 10 is an illustration of the effectiveness coefficient linked with multiple different descriptors as part of the artificial intelligence shown at FIG. 7, according to an embodiment of the present disclosure.

FIG. 11 illustrates a possible visual descriptor analysis grid where colors are extracted by the artificial intelligence as part of the invention described at FIG. 7 according to an embodiment of the present disclosure.

FIG. 12 is a chart illustrating the association between one heightened descriptor and general population moods as evidence of correlative effect of the intelligence, according to an embodiment of the present disclosure.

FIG. 13 is a detailed description of the intelligence crawling module as shown at FIG. 7 according to an embodiment of the present disclosure.

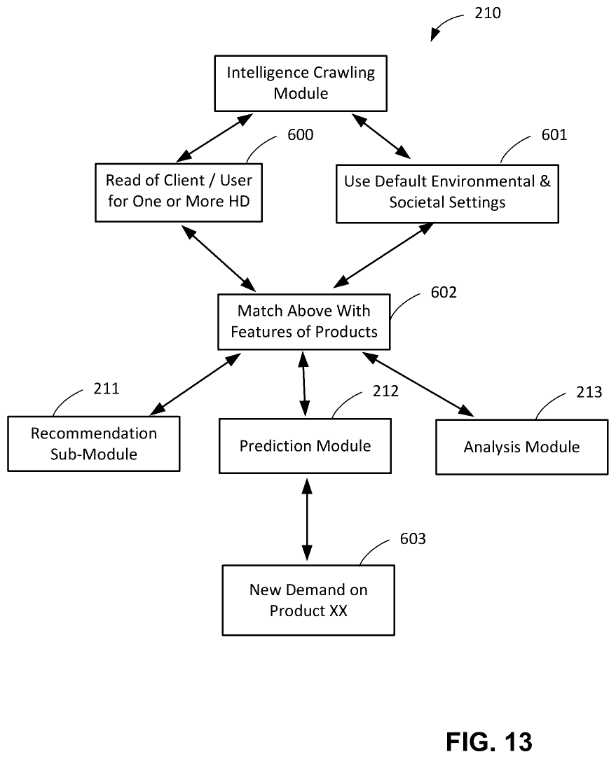

FIG. 14 illustrates at least a handful of the methods linked with the descriptor-based artificial intelligence for use on computerized affinity systems and associated methods of sales, data crawling and marketing thereof as shown at FIG. 7 and according to one embodiment of the present disclosure.

### DESCRIPTION OF THE PREFERRED EMBODIMENTS

Example embodiments will now be described more fully with reference to the accompanying drawings in an effort to fully describe this invention. As part of this specification, the present invention relates to a new artificial intelligence system, often described as an AI (e.g. Artificial Intelligence), operating for example on an affinity optimization computer-implemented system and associated methods of sales and marketing thereof.

Sample Hardware

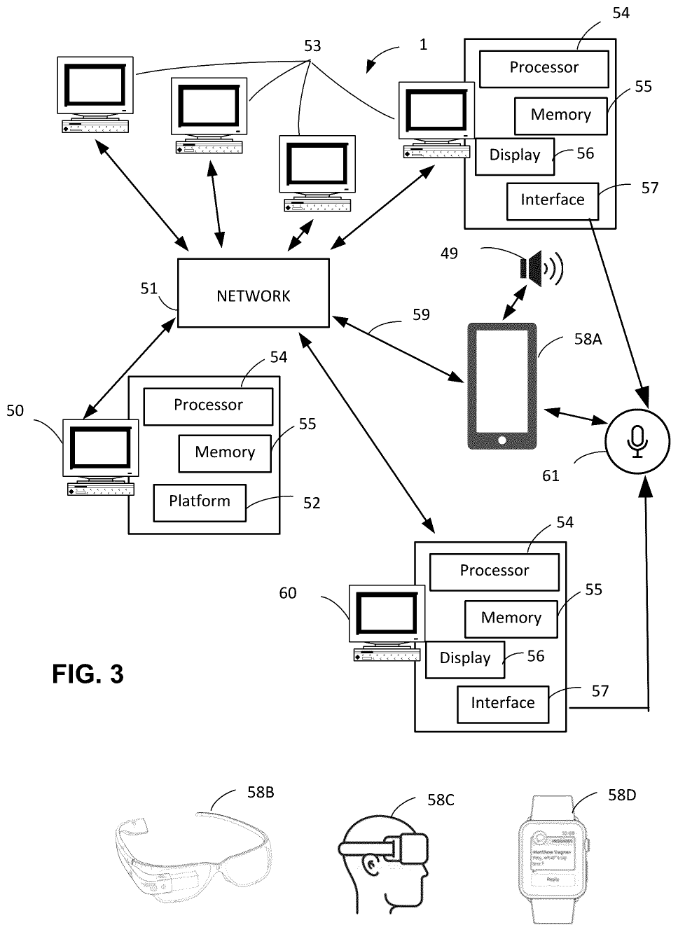

FIG. 3 is one possible schematic illustration of hardware used in a network configuration in which the descriptor-based artificial intelligence system for use on affinity optimization systems described hereafter and associated methods of sales and marketing can be implemented and operated. Computer technology really began to take hold in the mid portion of the 20^{th} century. By 1990s, in addition to private or closed networks, what became known as “the Internet” was progressively available to the public and entered into common understanding and usage. Back then, few were familiar with the general interconnectivity of the hardware elements used in any platform or system 1 as shown generically at FIG. 3. The Patent Office, asked practitioners to describe structure in which software, systems, and methods of operation of systems was to be implemented to help with the enablement. As of this day, most structural elements are common knowledge but remain described to help provide context and structure to the invention as implemented in the physical world.

Over time, phone networks began to overlap in functionality with online voice over IP networks allowing software like Messenger® or Line® to substitute with normal wireless carrier services. Today, most individuals own televisions who connect to wireless networks in addition to cable services. Private cell phones now offer (and people now are getting more familiar) Wi-Fi connectivity, Bluetooth® and Cellular services as alternative modes of transfer of data. The current invention is related to a new descriptor-based artificial intelligence system for use on affinity optimization systems and associated methods of sales and marketing that allows users to better market, buy or transact over the new systems either in actual reality (e.g. using software as a tool at a point of sale), in digital reality (e.g. using software as a tool to sell online), or in virtual reality (e.g. using software to augment actual and digital reality in a new virtual environment).

As part of the patent process, to enable mostly software-based patent applications, the intangible software must be connected to physical structure and include general description of the interconnectivity of these elements. With time, those of ordinary skill in the art realized how each of these elements and pieces, either in hardware and/or software, operate but as this slowly migrates into common understanding, remains a duty to describe hardware.

As described below, the current system and platform, while mostly software reside on hardware in one of multiple pieces of a system, as shown for example at FIG. 3. Since some materiality must be shown in association with the new system, a handful of elements are shown. The computer/software layer must be secure, reliable, and easy to maintain. Shown at FIG. 3 is one of numerous potential hardware configurations capable of hosting and executing the platform and system and for executing method of use linked thereto as described herein.

In its simplest configuration, FIG. 3 shows a system 1 with remote server 50 or any other type of computing device connected either wirelessly, via landlines, or in any way to a network 51, such as, for example the internet and/or a wireless cell phone system with or without data. As shown today, a plurality of personal computers 53 such as Personal Computers (PC's), laptops, hand held devices like a tablet 58A, a web-enabled phone 58A, or any other web-enabled device such as Google® glasses 58B, a Virtual Reality Set 58C, or an Apple® watch 58D each generally are built with a computer processor 54 are in turn connected to the network 51. As shown at 49 is a speaker for playing .wav files (aka sound files) which can be equipped on most computers. Such speakers, for example on cell phones or portable watches are connected via Bluetooth data transfer format as part of wireless ear pieces. Other human interfaces also exist and shown as elements 58B, 58C, or 58D of FIG. 3 of all types. One of ordinary skill in the art will recognize that while one configuration is shown, the inventors are not restrictive as to the applicability of the currently described technology.

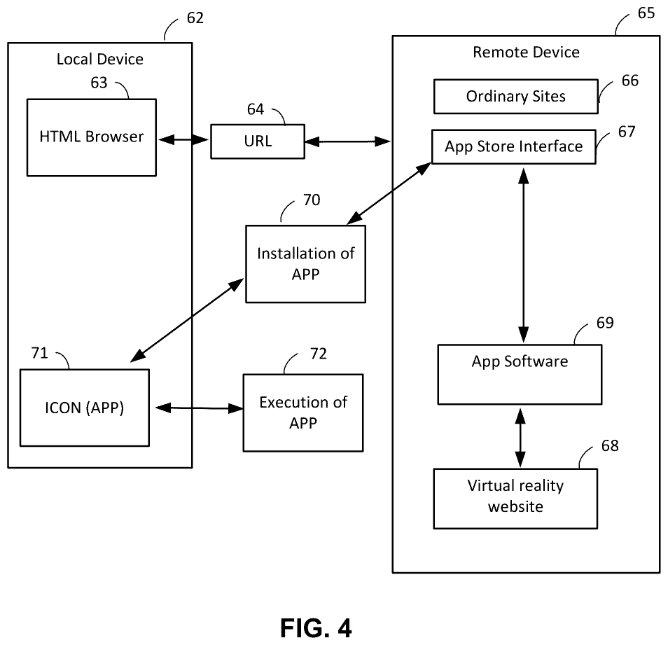

Returning to FIG. 3, the server 50 or the personal computers 53 can broadly be described as having a processor 54 each connected to a computer memory 55 designed to operate in tandem with the processor 54 to execute several layers of software needed for operation (e.g. operating system, bios, internet, etc.). In addition, most devices 50, 53, or 58 have a display 56 for use by a human user. In the case of a watch 58D, the display is on a wrist, in the case of a virtual reality set 58C, the display is facing the eyes of the user, and in the case of glasses, the semi-transparent display is created using an external light source. Such display 56 is generally found on the server 50 but is not absolutely needed. The personal computers 53 do in fact require some type of computer display 56 connected to the computer processor 54 for interaction with potential users using the platform 1 hosted in the hardware shown at FIG. 3. The display 56 helps the user navigate over a software interface 57 as shown at FIG. 4, to display different information in the computer memory 55 by the computer processor 54 over the interface 57.

FIG. 4 illustrates generally the software structure linked with the use of local v. remote devices 62 v. 65 to exchange information and how browsers in HTML formats leverage URLs for surfing cites. Also described generally and shown at FIG. 4 is the process of how Apps are stored and uploaded from App-stores and the same concept applies to any and most layers of software. Returning to FIG. 3, also shown, is a cell phone 58A which is also connected 59 to the network 51 either via Wi-Fi or cell-phone means or any other means. One of ordinary skill in the art will understand how cell-phones, now fully autonomous machines (e.g. 50 or 53) also includes the features of a full computer. The same can be said of electronic watches 58D, virtual reality sets 58C, or computer-based glasses 58B. In the above, what is also shown is a remote third party server 60 also equipped with similar features of a processor 54, a memory 55, a display 56, and an interface 57 which for example serves as the depository of a software or an App (aka the App Store) where hundreds of thousands of Apps are located in the memory 55 and can be accessed via an interface. One of ordinary skill will understand that such structures are subject to change with technology like cloud storage, remote storage, blockchain ledgers, etc. The same way, Facebook® rebranded to META® and using the Oculus® headset, now has created, the same way App stores manage software kernels from third parties, a new virtual reality world that is built with third-party ownership/content. This new virtual reality adds a layer of direct user interface and relies upon technology which as functions such as cameras to monitor eye movements, cameras to film and offer real-world transparency and other such features. As part of the virtual reality world, an App store is also present, electronic currency and even real-estate like features exist for third party ownership.

Within the scope of this disclosure, the term computer display 56 includes more than a screen or other visual interface, the term display is designed to include any interface capable of interacting with a person, whether visual, oral, touch, or any other interface. A personal computer 53 also includes running as part of the memory 55 and displayed on the computer display 56 an interface 57 and is connected to the computer processor 54. Also as shown, this interface may include a microphone 61 connected to the devices 53, 58, and 60 which allows for recording of sound and words for use by a system which is designed to process human voice.

The Internet can be used as the protocol of communication using, for example, the HTML protocol. Other networks are also contemplated; for example, wireless networks, internal networks, or other non-HTML networks. As the current platform is expanded and new technology arrives, one of ordinary skill will know that the concepts shown herein can be applied to other networks, and to new technology as currently used over the Internet and wireless networks.

Sample Software/FIGS. 4-6

After describing generally the hardware and network layer at FIG. 3, what is offered is sample software structure later shown at FIGS. 4-6 in which the invention can operate and process information. Not shown explicitly is the technology associated with database creation, use and storage in memory in which descriptors and HDs are stored for a plurality of products or services. Such concepts are incorporated herein by reference, for example, the content of the website relating to databases, structured query language (SQL), spreadsheets, types of databases, database management systems (DBMS) or associated uses and methods is incorporated by reference.

Shown is a remote data server 50, used sometimes to store data used by any software application as shown generally at FIG. 4. For example, in recent years Cloud-based technology allows for more fluid data management by relying on a network of servers 50 located in different physical locations around the world. Different rooms are connected to the Internet to help manage the system, offer users rights and manage the flow of data. To help the reader understand, while the illustration shows desktop computers 53, over time users have become more familiar with less bulky systems and equipment capable of also accessing the Internet 51 or other network. For example, today's wireless phones now offer owners almost full surfing capabilities through browsers and double capacity transceivers. Now that the general structure of hardware used by users (locally or remotely) has been explained and the overall network configuration of hardware 1 as shown at FIG. 3 is accessed by different users, we will next explain how each of the devices 53, 60, 58A, 58B, 58C, and 58D can host and empower multiple types of software to operate within these devices alongside (when needed) phone communication. FIG. 4 is a high-level schematic of the different internal layers to process information by the different hardware elements shown at FIG. 3, according to an embodiment of the present invention.

FIG. 4 shows how the HTML Browser 63, located installed and located (upload and executing) on any of the devices 50, 53, 58, and 60 shown at FIG. 3 all include sufficient low-level software layers which allows for the execution of operating systems able to run one of numerous internet browser such as Mozilla® or Explorer® that each can be installed locally and run inside the memory via the processor can be used to connect via a Uniform Resource Locator (URL) 64 to one of any websites 66, 67, or 68 at one of numerous remote devices 65. Illustrated on the remote device 65 includes ordinary sites 66, an App Store Interface 67, and a virtual reality website 68 as described below. This website 68, for example, use via the HTML Browser 63 and the URL 64 to connect to the Website 68 located on the remote device 65 for the generation of an App Software 69 to be placed upon the App Store Interface 67 for installation 70 back to the Local Device 62. This App installed 70 then appears as an icon 71 on the local device 62 which if clicked will launch the App 72 that has been generated 69 by the website 68 and sent for upload in the App Store 67 for installation 70.

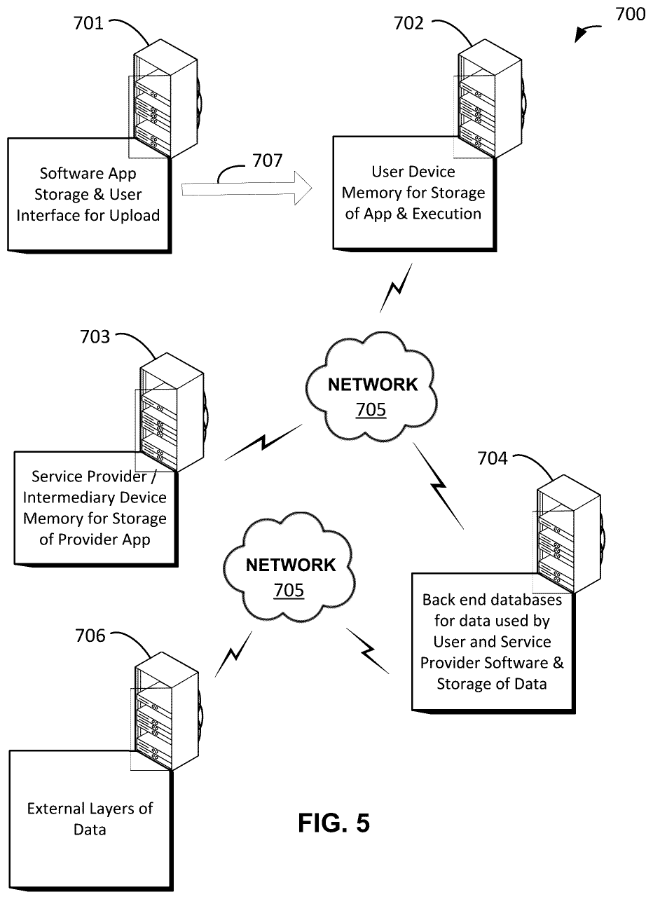

At FIG. 5, what is shown is a network of back-end servers 700 to replace the server 60 as shown at FIG. 3. Many understand today with cloud-computing and App-database service that while one server 60 is shown at FIG. 3 for simplicity purpose, in fact network includes a first server 701 where Software Apps are stored & User interfaces are also located for upload. A service provider 703 may have intermediary devices and memory for storage and to provide software like Apps connected to a network 705 to help manage the situation and speed processes up. On a user device 702 as shown at FIG. 3 as 50 for example, the memory and storage locally can store the App and execute the software. Remotely, multiple back end databases 704 can be used also connected to a network 705 to help manage multiple layers of external data.

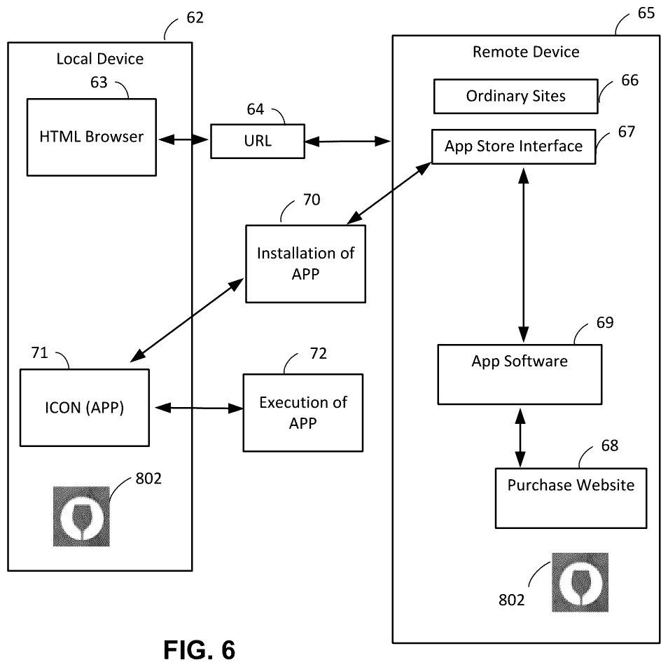

As shown at FIG. 6, in addition as described generally above and below with great specificity and shown at FIG. 4, a stand-alone App instead of a website which serves the same purpose but has to be pre-installed on a person's device 62 as shown, an App 802 can be located on the App store 69 for upload via the App Store Interface 67 and installation 70 locally. Offering a different choice (i.e. an App instead of a website) is only illustrative of how this technology can be offered in one of multiple ways on different tablet, a voice-enabled watch, etc.

Recently, with the expansion of connectivity to handheld portable devices, software which once was confined to desktops or servers now has migrated to these devices. A remote store on a server houses multiple “apps” (i.e., an executable file in .app format) which can be uploaded directly by a user into the memory of a portable device for execution. Most of these apps then connect via wireless technology to a remote server where the main software application resides and operates. These apps often serve as satellite software capable of interacting with a remote base for multiple functions. As for the above-suggested embodiments, this one is simply illustrative and not designed to limit the platform in any way.

Apps, once they are programmed, are uploaded using an online portal onto a service provider; for example, the App Store® from Apple®. Currently, many software programs use a local HTML browser installed on the computer, along with their associated displays and interfaces, for example tablets, cell phones, portable or fixed computers with a commercial browser tool such as Internet Explorer®, or Mozilla Firefox® to exchange information for the most part in the form of HTML script and data linked with the HTML script and display based on the format of the browser. The platform software, while programmed in any of multiple programming languages, relies on any one of multiple database tools, and can be made to read and generate content that can be accessed by the remote HTML browsers. Also contemplated is a display where said display is used to block the entire perceptive field of a user creating the illusion of a new digital reality in which the person is immersed (aka Virtual Reality). Such new space/area offers similar properties and new inventive features as described below.

The Descriptor(s)

As part of this invention, the inventors describe and refer to a structure information in terms of “descriptors” aka “features” aka “elements” which in part are used to define a good or a service. The inventors understand that good or service, offered to customers or users in some abstract vary from their peers or competitors in one or more ways that can be defined as part of a list of descriptors, a list of features, or a list of elements which are used to describe any of the goods (aka products) or service. If descriptors are applied to a person, features like the height, the weight, the eye color, etc. may be extracted. If a descriptor-based analysis is applied to a product, features like its price, the size, the functionality, can be used. The same way, in case of services instead of goods, features can also be extracted as descriptors for every type of service offered. For example, if yoga classes are offered, descriptors can include the location, the number of students, the qualification of the teacher, etc. One of ordinary skill in the art will recognize that as part of the structure of information for processing by any artificial intelligence, the inventors have broken down the world, the products or the services found therein into a plurality of descriptors often saved as different elements in a database.

Visual Descriptor (VD)/Functional Descriptor (FD)/Descriptive Descriptor (DD)

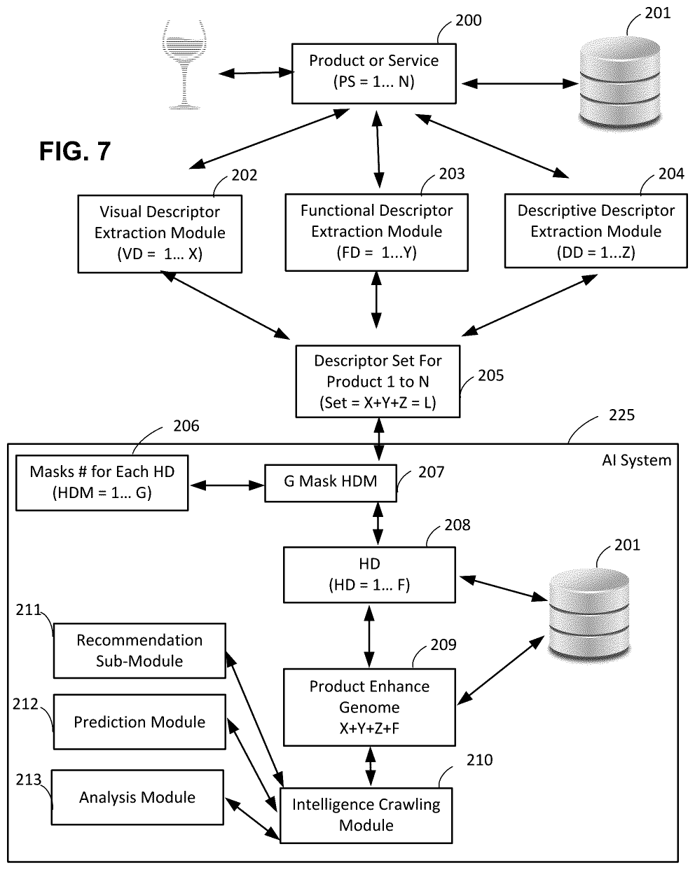

The inventors categorizes the descriptors into three main categories. While three are given, the inventors understand that based on the field of use of this invention, other family of descriptors may be needed or used and may be more relevant to the technology application at hand. As shown at FIG. 7, the inventors have broken down descriptors of any good or service into a set of visual descriptor (VD) as shown at 202 representing multiple elements that can be perceived in the real world or digitally about the good or service, for example, in the field of goods the visual descriptors may relate to packaging, display, colors, or other such features and in the field of services, the visual descriptors may relate to the visual nature of individuals or locations where the service is offered. To help understand any product or service (or group thereof), the inventors have noted that a number of VD can be created and to help with describing this technology, a number is given N=1 to N for any product 200 as shown. The use of the letter N is only a rational number that is greater than 1 and can be any number.

A second group used is functional descriptors (FD) 203 as shown at FIG. 7, which in turn do not relate to what something or someone looks like but instead what it is or what it does. A product for example may have taste, effects while a person may have qualifications. A car may have mpg ratings, speeds, etc. One key distinction between the VD and FD category is the capacity by a computer to easily perceive and quantify a VD over a FD which often will require greater effort or even manual data entry. To help understand any product or service (or group thereof), the inventors have noted that a number of FD can be created and to help with describing this technology, a number is given N=1 to Y for any product 200 as shown. The use of the letter N is only a rational number that is greater than 1 and can be any number. One of ordinary skill in the art will understand that while Y is any rational number, it may coincidentally be the same as X as part of the analysis of any product 200.

Thirdly, at FIG. 7 is shown a group of descriptive descriptor (DD) as a third category is often valued descriptors which relate to how a product or service is described, opined upon or spoken of. For example, a DD can be a star rating, the opinion of an expert, etc. To help understand any product or service (or group thereof), the inventors have noted that a number of DD can be created and to help with describing this technology, a number is given N=1 to Z for any product 200 as shown. The use of the letter N is only a rational number that is greater than 1 and can be any number. One of ordinary skill in the art will understand that while Z is any rational number, it may coincidentally be the same as X or Y as part of the analysis of any product 200.

Definition of Heightened Descriptor (HD) and HD Mask (HDM)

As shown at FIG. 7, as part of this invention, the inventors have found that while individual descriptors have value (VD, FD, DD) 202, 203, 204, a greater value is placed upon what is described and called a Heightened Descriptor (HD) 208. Such HDs are generated created from a subset of visual, functional or descriptive descriptors (Set=X+Y+Z) 205 selected and weighted carefully using Heightened Descriptor Masks (HDMs) 206 unique to each set as a new descriptor. As shown at FIG. 7, each mask 207 is created from a subset of G of the full set of descriptors 205. One of ordinary skill will understand that while FIG. 7 shows only the VD, FD, DD as input descriptors to the marks 206, it is possible for the marks to rely upon other HD as part of the input set. For the moment, the inventors as part of the field-specific embodiments contemplated have found that each of the HD are different and serve a different purpose as part of the analysis and do not need to be cross-used. But as explained above, such efforts can be different depending on each field.

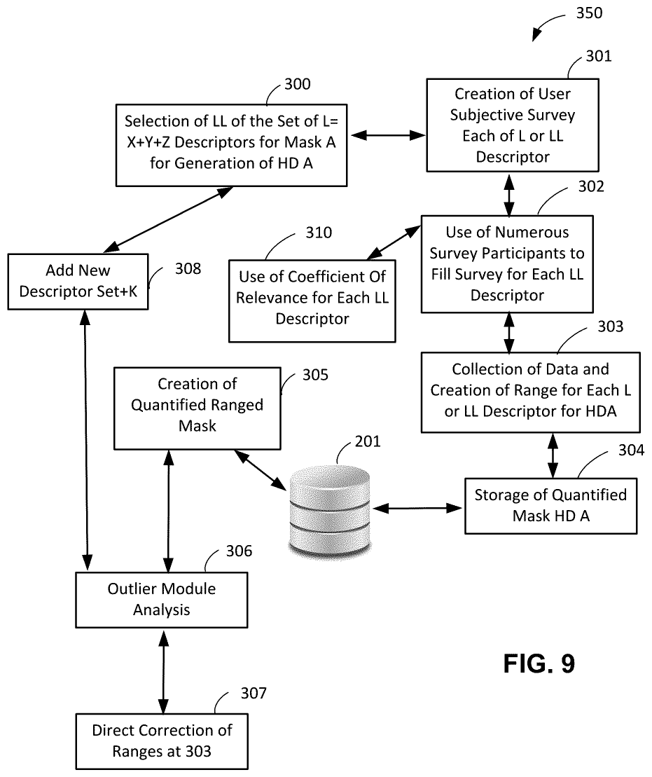

As shown at FIG. 9, each such HDMs 206 may be built in iterative steps 350 which includes the initial selection of a number L of descriptors from the total set of descriptors X+Y+Z extracted for a given product or service 300. For example, if the artificial system as described generally at FIG. 7 has extracted a total of L=65 descriptors in the XYZ set, then a specific HD mask A for the generation of a HD A (e.g. scary, or trusting), the system must select an input subset of LL of the creation 301 and use of a survey 301. For example, the inventors in the field of wine have found that customers often will like perception values, such as feelings or emotions linked with a product. For example, bottles may be given an HD or “strength (HD A)” or “cheerful (HD B)” or even “emotional (HD C).” Each of the subset for example may be HD A (L=65, LLA=5), HD B (L=65, LLB=6), and HD C (L=65, LLC=3) where the 5, 6, and 3 descriptors used may be identical in part, or completely different between the different masks.

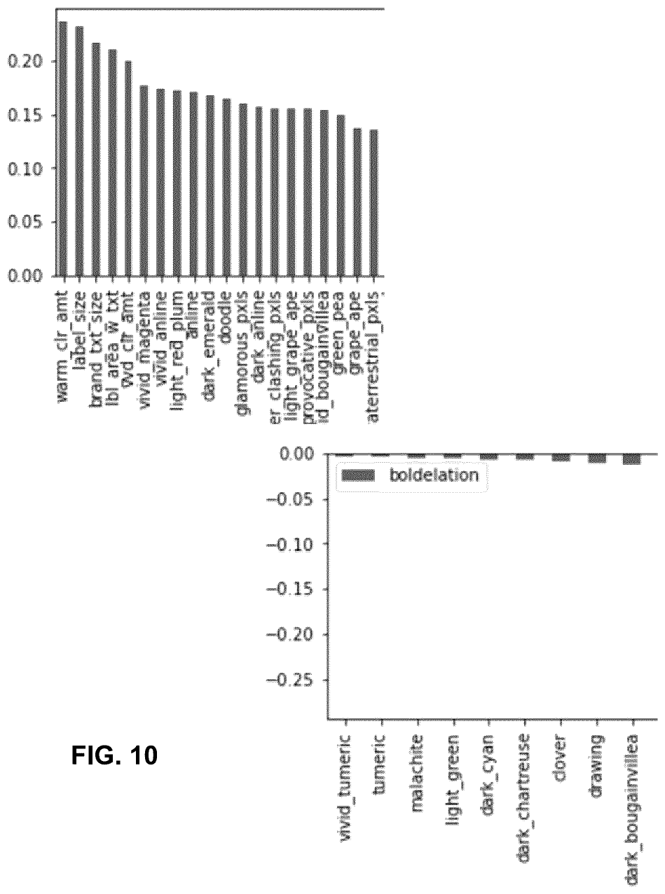

In the above if LLA has five descriptors of the L set relevant to “strength” are “dark color label”, “angles on label,” “dark-red theme”, “word count” and “sauvignon grapes”, and LLC has three descriptors of the L set relevant to “emotional” would be “white”, “round shape label” and “white wine”, then system would then apply as shown at 310 of FIG. 9 possibly a coefficient of relevance to each descriptor found in the database. This coefficient, contemplated by the inventors as a value between 0.01 (i.e. 1%) to 1 (i.e. 100%). In another embodiment, the inventors have found that to simplify the model, instead of a selection LL from the L set 300 to create a subset, all of the set L could be used if the coefficient of relevance 310 is simply modulated for placing any given descriptor that is unrelated to the model to 0.01 (i.e. 1%) or any other such minimal value. FIG. 10 shows one sample embodiment of the inventors where some of the descriptors (horizontal elements) are given different coefficients that vary in a positive range of +0 to +0.25 and in the negative from −0 to −0.30. Once again, one of ordinary skill in the art will understand the use of coefficients 310 can also be scaled base on the number of descriptors in a mask (e.g. above 5, 6, and 3) where each total 1.00 or 100%. In another model, certain features are discounted to vary from a normal 0.00 and where the coefficient 310 is in fact a way to offset the value from a neutral ground.

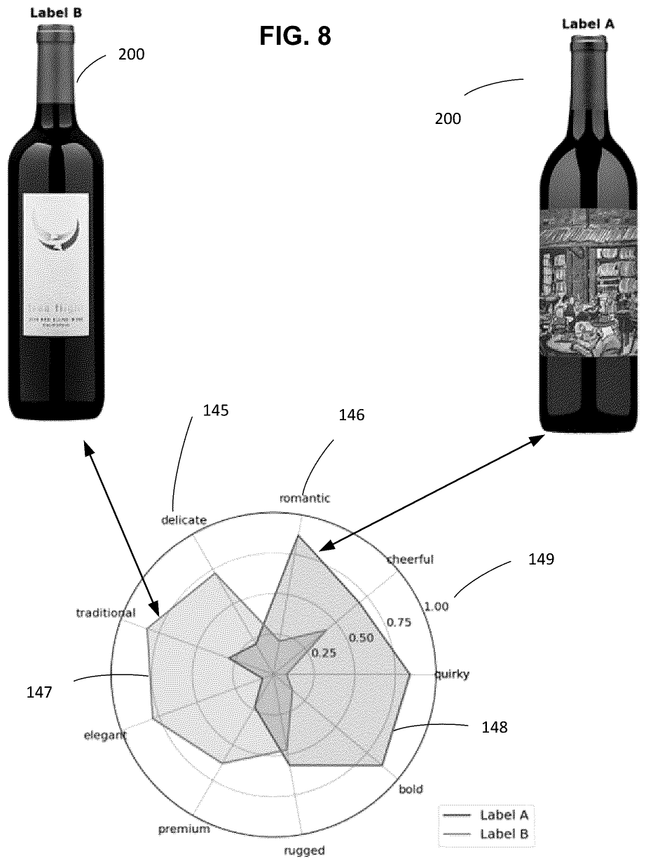

FIG. 8, shows how any product 200, given a long list of HD (up to F) 208 can be made to be part of the product genome 209. This information updated to the database 201 can be displayed for example in a spider graph where only the HD's are represented. At FIG. 8, F=9 and a total of nine HD's are shown 145, 246. The HD's include delicate, romantic, cheerful, quirky, bold, rugged, premium, elegant, and traditional. Each label, given a different score on each HD 147, 148 as part of a spider graph representation. As shown a value 149 ranges from 0 to 1 and is illustrated using this method. While one type of graphical representation is shown, what is contemplated is any known representation method.

The same way, as shown at FIG. 9, the inventors contemplate the use of a subjective survey for each of the descriptors (either L or LL). Such surveys are not normally designed to quantify any value or a range but only to validate the model or to adjust the values and correct the calculated values using third party validations. In another embodiment, the surveys are only used to capture human subjective perception ratings for HD as part of the training set. The invention then reviews the VD/FD/DD patterns of those 200 or so surveyed wines in the training set to create predictive models for wines that were not part of the survey training set. The VD/FD/DD are all automatically extracted using computer vision and machine learning techniques. In this embodiment, little to no human involvement is used for those attributes. The only human involvement is the survey to capture their perception ratings for the 200 or so training set bottles. In a first model, questions are generated with featured products with the selected descriptor of the mark (shown as Mask A HD A) in FIG. 9, and where users are asked over a computer interface to simply quantify subjectively the shown product. For example, if a “cheerful” HD is quantified as the potential HD, a person would select either one single wine/product for display to the user and for quantification 302 to enter data as to “do you believe the shown wine is cheerful, score on the slider, left being very cheerful and right being low cheerfulness.” The data is then collected 303. In another contemplated mode of survey, instead of simply showing a single wine label, a total of three are selected and the user is asked to “pick the most cheerful” and “pick the least cheerful” to help collect data 303. While two modes of data collection are given, one or ordinary skill in the art will understand that many different can be used.

The inventors understand that the data collected 303, in order to set initial parameters, the data is scaled or ranged for each of the descriptors. For example, for a “cheerful” descriptor, the number of angles on a wine label, once shown to individuals 302 via the survey 301, can be found that when a round label (aka 0 angles) is found, the users score high in cheerfulness. In contrast, if seven angles are found on the label, the score is the lowest. This will allow for the system to create a range for the descriptor only as to the “cheerfulness” HD descriptor A. One of ordinary skill in the art understands that the descriptor “number of angles” could be also used for a different HD such as “creativity” and for such a survey 301, entry of data 302, and collection of data 302, the use of a rounded label may score low on creativity. The survey 301 may adjust values.

The inventors have determined this one way for the entry of initial parameter set into model mask 304 into the database 201 as shown at FIG. 9 for the creation of quantified ranged mask 305. One of ordinary skill in the art will understand that another means of pre-calibration of the descriptors of a mask may be from the importation such data from a different model as simply the initial setup. For example, a user selling wine and having conducted the survey steps for descriptors as shown at FIG. 9 may want to sell the technology to someone selling flowers. In the case of flowers, the set of descriptors X+Y+Z may be mostly irrelevant but some of the features or descriptors may be relevant. For example, a color descriptor may apply. One of ordinary skill in the art of management and reconciliation of database data might understand how this process may be somewhat simplified using some level of reconciliation. Also what is contemplated but not disclosed as the current best mode is a simple subjective one-person entry of opinions and data.

The inventors have also found that artificial intelligence and such models greatly benefit from any type of reconciliation and adaptive learning. For example, in the above case, a product may have a label that is an “outlier” or something so creative or different that it may offset the model. A label could be made with little crenelated castle-like edges. In the above model, when individuals were shown angles, they found a HD linked with “cheerfulness” to be lowly scored by many angles. Such a new shape would have 20+ edges and angles but could still be very “cheerful” or other positive perceptive traits. The inventors have discovered that while they could simply use a module to correct the range 307 as shown at FIG. 9, in this example, since the range is set for “more” is “less” the outlier is in fact in direct contradiction with the model as ranged. Changing a range would not help the model in this instance. The inventors have created a module 308 where instead of changing any parameter, a new descriptor is reviewed and added to the model L to increase both L and LL for the analysis. As part of this technology as described above in the example, a new “castle feature” descriptor could be created where any element like a drawbridge, crenelated features, as part of a new VD. This new level of adaptive learning, also described as artificial intelligence allows to increase the population of descriptor and forces a complete review of the model. In this example, once a new descriptor has been “found” and added to the VD set. A review of all of the HDs created would be reviewed periodically to see if the new descriptor has relevance to it. For example, if the value was added in response to a “cheerful” analysis, the same new descriptor for example would be very relevant to something “traditional.”

As part of the perception analysis and the survey 301 for each of the HD, the inventor notes that often, certain HDs can be better understood in a two-word range (e.g. spectrum of modern to traditional) instead of a single word range (e.g. low modern look to high modern look). Some of the most famous emotions, qualifies, perceptions are actually often best understood as part of a spectrum for better use by the artificial intelligence. For example, a gym trainer which demonstrates extreme respect to performance metrics (e.g. will force a client to run at 7:10 min/mile and not 7:12 min/mile) which contrast with one that is more intuitive (e.g. will force the same client to monitor and manage breathing and fatigue).

To the inventors, the Artificial Intelligence, using HD's each connected to its own HDM and associated with sets of basic descriptors, alone or in combination with these basic descriptors allow for the AI to perceive or have a heightened understanding/feeling about any good or service. The AI is programmed to generate new HD for each good and service and store that information alongside. Next, the AI is programmed, as part of the system to use and leverage these HDs in a way that allows for improved performances, marketing and sales. Also, the inventor has found that the AI programmed accordingly helps advance multiple uses, including over new tools and interfaces like, for example actual reality, digital reality or virtual reality.

The AI System

Shown at FIG. 7 is a general diagrammatic view of the different modules of the entire descriptor-based artificial intelligence system for use on affinity optimization systems and associated methods of sales and marketing. As shown, a database 201, often in a format for the storage of a large number of products or services N 200. On FIG. 7, one glass of wine is shown as the product. As part of this invention, shown is a large number of products or services (PS) listed as 1 to N, where N is the total number of products or services in the model in use in the field of examination by the AI system.

The first module 202 referred often in the field of wine by the inventors as the “Label AI” is listed as the Visual Descriptor Extraction Module (VD) and where such module includes (a) a number of defined descriptors of interest (VD ranging from 1 to X as shown). The module includes both a manual entry portal, and also an automated visual tool with camera able to conduct analysis for each of the X VDs. For example, module 202 is limited in that is analyzes parts of the wine product, the packaging, or other such elements. An example of wine packaging descriptors can include: screw cap, cork, wax, primary colors, secondary colors, bright colors, dark colors, bold colors, soft colors, castle, vineyard, family crests, animals, people, picture, artwork, logos, printed name, for example. The system AI is programmed with the definition of a set of VD of X. The inventor also teaches that while the AI can be automated using digital recognition, the system can also be automated to process digital images from the web.

Once these different descriptors are quantified and linked with any given label, there may be a multi-field entry into a large database for each product. As a result an entry in the database recording the wine attributes is shown in the following table consisting of traditional descriptors like country, region, etc., and the packaging descriptors described above.

For example, in a database a wine can be described as:

| Product | Country | Region | Appellation | Varietal | Cap | Primary color | Animal |
|---|---|---|---|---|---|---|---|
| 25613 | USA | Napa Valley | Howell Mountain | Cabernet | Cork | Black | 1 |

The above wine example can be extrapolated to a car example in that the system will read all visual attributes of the vehicle, including the color, the shape, the number of mirrors, the type of wheels, etc. In contrast, at FIG. 7 is a second module 203, named internally “Wine AI” and shown as Functional Descriptor Extraction Module 203 (FD) is designed to extract from each of the products 200 a set of Y descriptors. This portion of the descriptor-based AI extraction module which focusses on the content of the product and what it does in contrast to simply how it looks. The module 203, for example can be populated with quantifiable factors such as different notes of taste (e.g. fruity, plumb, tannin, etc.). Module 203 could, for example include the alcohol percentage, descriptive of the color of a product, and even the way it was produced or stored. Module 203, when applied for vehicle technology would be less subjective to quantify and may be more important for some potential customers. For example, the Wine AI module 203 would know the maximum test speeds, the gas consumption, the type of gas/diesel, the life of a charge of battery, the number of horse power, etc.

FIG. 7 also lists a third Artificial Intelligence module 204 also programmed for a different number of descriptors Z but called simply “Language AI” internally or Descriptive Descriptor (DD) which is a third set of product descriptors secured in a third important way. Instead of looking at the product itself (Module 202) or what the product does or tastes like (Module 203), the system is a linguistic AI designed to secure additional descriptors from mostly data. For example, in the case of the internet, this system would have a Language AI module 204 designed to scour the internet, read comments and blog posts and be on the look out for key descriptors. For example, if an award is won by the wine or the vehicle, if a blogger reports defects, etc.

FIG. 7 shows modules 202, 203, and 204 as part of the data mining stage of the AI. At Module 205, a full descriptor set Set=L=X+Y+Z is created for each of the N products 200. These three combined modules are designed to mine, secure and enrich a database where each of a number of “products” or items in the database is given as many descriptors as possible. The inventors have found that, depending on the technology to be used in a database, depending on each type descriptor, classification in a database or a scaled quantum can be represented by a binary value (e.g. 0 or 1 also often called normalized values in a range of 0 to 1), categorical values (e.g. colors), or as an ordinal value which represents an intensity scale with a predefined range (e.g. 0 to 10 or 0 to 100 under a scale) as shown in the table below:

| Descriptor | Module | Type | Example |
|---|---|---|---|
| Animal | Label 701 | binary | 0 |
| Family Crest | Label 701 | binary | 1 |
| Primary color | Label 701 | categorical | red |
| Secondary color | Label 701 | categorical | black |
| Alcohol % | Wine 702 | Normalized | 14.5% |
| | | | (0.145) |
| Opacity | Wine 702 | Categorical | Transparent |
| Color | Wine 702 | Categorical | Light red |
| Review | Lang 703 | Normalized | 4 starts |
| Medal | Lang 703 | Binary | 0 |
| Problems | Lang 703 | Categorical | Delays |

This table shows how descriptors are different things, and where a type of classification (e.g. binary, categorical, or ordinal) can be used and also how each of the Modules 701, 702, 703 populate descriptors for each of the product. In the above, this table may relate to one product (e.g. one wine). While a handful of types are shown, one of ordinary skill in the art will recognize that others can be contemplated.

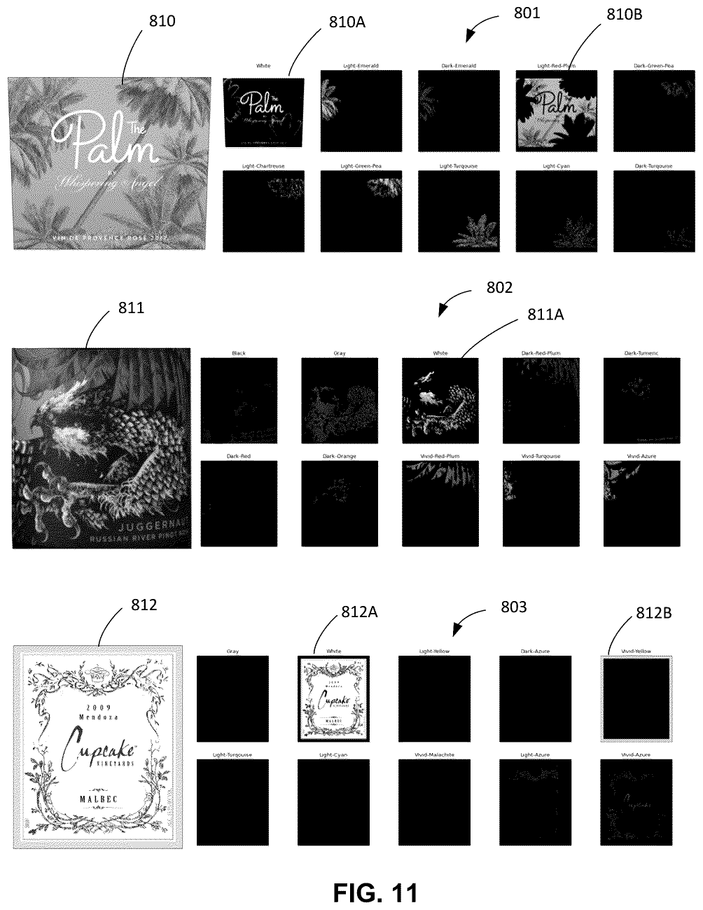

In the above, the visual descriptor extraction module 202 as shown at FIG. 7 requires more information to be fully enabled. The inventors have created a system where once one product 200 of a set 201 is entered and digested, the system as a whole is able, once it has been given all VDs, FDs, and DDs, to also be given all HDs to complete the full set to create the ‘genome’ 209 of the product 200. As shown at FIG. 11, one single tool used to quickly pull out any descriptor from a product 200, here the colors of a label is shown. The inventors have found, for example, that the label color(s) is a key descriptor when associated with wine. As part of labels of wine, simply having a dark colored label or a light colored label did not suffice to capture the complexity and need for the creation of the HDs. As a consequence, the inventors have created a more detailed layered analysis map where any one label 810, 811, 812 as shown at FIG. 11 is broken down into a total of 10 different sub maps or layers each with its own descriptor. While 10 colors are shown, the choice can, for example be made with up to fifty colors each given part of a collective analysis. In both cases of 10 and 50 colors, the sum of each can be made to unity (i.e. 100% of the surface must be given one of the selected template colors). In another embodiment, more than 50 colors are contemplated. As shown 801 is a method to extract visual descriptor simply by using a camera which looks at the image. It will then process the different colors one after the other in subsequent maps and also use simple tools to quantify the volume and ratio of each color. In the above, simple descriptor can then be applied to the data secured very quickly. For example, white 812A is dominant in the third example and the system may qualify the label of mostly white while the first label 810 because of the dominance in surface of the color pink 810B will qualify the label accordingly. At 811 for example for label 802, no color clearly dominates but the dark values over the light values 811A may dominate. Once again, the use of automated color analysis can be done either from a camera source of real image or from a digital file already created for each product 200.

In this example, for example, one HD mask might find that if a dark blue is used and found in large quantity, generally this image is linked with an outside scene or the sea and would be a factor in a mask for the ‘perception’ of tranquility.

The current invention relates to and all technology linked with marketing, sales and advertising. But the inventors are expert in the field of packaging and labeling in the field of wine sales. Labels are known as printed surfaces, generally of paper, which include branding, logos, designs, colors, and other information which allows products to be sold in commerce. When two brands, labels, or designs become confusingly similar, they will create confusion in the mind of consumers and trademark laws will help owners enforce their respective marks. This allows the inventor to assume that different labels can be distinguished without confusion by consumers using one of multiple elements listed above. But the inventor also understands that in the digital world, labels can be either physical (e.g. paper) or digital (e.g. image). This does not alter the below description.

The inventors also have found that people, even at a glance recognize multiple features or descriptors linked with each different label/product to be sold. The inventors note that any product to be sold will include a primary descriptor, a secondary descriptor and what we describe as subsequent descriptors. In the event of a manageable list of descriptors as shown at FIG. 10, this AI can be extrapolated to encompass large numbers of products 200 or services. In one narrowing or simplifying variations of this invention, each individual, after looking at any given product will remember one, two or even more “dominant” features. For example, a picture of a new car is shown. While a first individual shown a new car may state as the descriptor set (i.e. primary, secondary, and subsequent) to be (a) red, (b) convertible, and (c) four doors, a second individual may see the same illustration and provide, when asked a completely different set of descriptors such as (i) convertible, (b) Ford®, and (c) sports car.

| Primary | Secondary | Subsequent(s) |
|---|---|---|
| Red | Convertible | 4 doors |
| Convertible | Model | Vehicle Type |

As part of the artificial intelligence module described herein and hereafter, the first portion of the analysis (when needed) may represent a correction factor for each of the descriptor based on the way any given individual will determine for himself/herself what is the primary, secondary, and subsequent descriptor could be. For example, certain individuals will focus on models of cars when others will focus primarily on colors. The same way, in the world of wine, certain individual will primarily focus on age of a wine and others will focus on their country of origin. The invention includes a filtration module F(M) which is designed to diagnose, quantify and then apply a coefficient factor Keff for each descriptor. If an individual is not known, for example, such a Keff will be set to 1. In the case of a six descriptor analysis (n=1 to 6), a different Keff will be assigned for each of the descriptor according to relevant importance given.

Pairing of HDs With Marketing/Sales/Data Mining

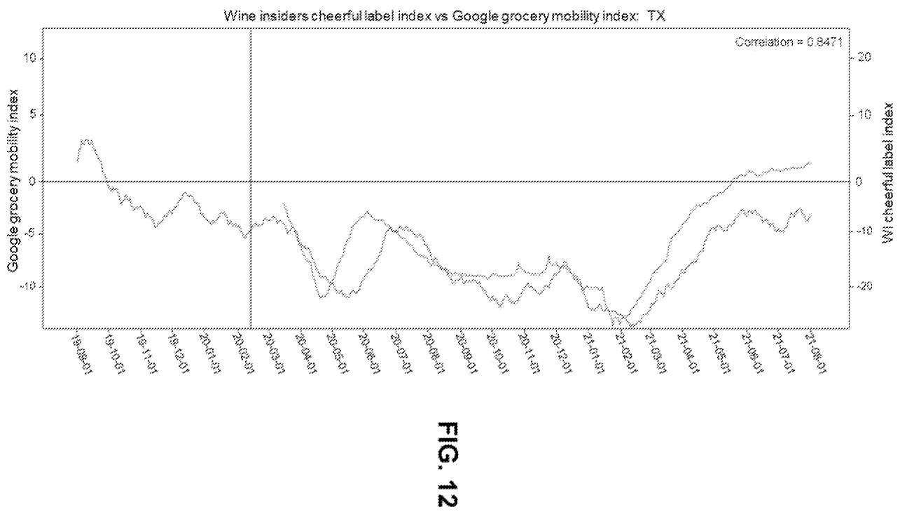

The inventors have also uncovered that the creation of masks 206, each to be applied 207 for the determination of a HD 208 for each product in the database 201 is the start of the Artificial intelligence 225 as described above. But more importantly, this results in a product 200 being enhanced 209 with multiple HD 208. But the inventors have discovered several key correlations which—shockingly—empower this artificial intelligence 225 when apply to an affinity system as shown in the figures which can help generate multiple key new inventions. As shown at FIG. 12

As part of the figure, a grey line showing the Google® mobility index that shows how mobile is a population at a point in time between 2 years. For example, during the lockdown linked with the Covid-19 pandemic, the population was not really mobile. On the scale on the other side the consumer's actual profile in purchase of a wine which has “cheerful” as the key perception metric. As the people's mobility was lowered, so was their happiness. Contrary to what people may think, the purchases of wines were not designed to offset a mood of the consumers but actually tracked this mood. The correlation is shocking when compared to only one HD and not even the full genomic map 209 at FIG. 7 of the product 200. For this reason, the artificial intelligence 225 as shown at FIG. 7 includes and incorporates multiple tools to help leverage this new technology 210.

The intelligence crawling tool 210 as shown at FIG. 7 relies upon the notion that the inventors have found that unique and central to the process of marketing, sales and purchasing are the different feelings, emotions or perceptions of clients at the time of purchase. The same person/user would be receptive to cheerful as a descriptor and such mood is more likely to preface and initiate a decision to buy than others. Such conduct is often seen in real life when individuals always group themselves in certain “cultures” such as was portrayed in the movie Breakfast Club. In that picture, the “jock” often would gravitate toward certain colors, certain clothing, certain vehicles, and certain classes because of this identity. In contrast, a “goth” would gravitate to different elements in terms of colors, clothing, vehicles, or classes.

The inventor has broken down moods in pairs often at the opposite of the spectrum, these include (a) Modern/Traditional, (b) Gloomy/Cheerful, (c) Crude/Elegant, (d) Playful/Serious, (e) Ordinary/Unique, (f) Safe/Dangerous, (g) Cheap/Premium, (h) Plain/Eye-catching, and (i) Boring/Intriguing to name a few. Using such pairs, descriptors can be created and allow for example ranking using the above type (e.g. Binary, Categorical, Ordinal value). For example, in the Cheap/Premium descriptor, a simple Binary value (e.g. 0 is cheap and 1 is premium defined at $50) or Ordinal (e.g. a normative value in the 0 to 1 range with a price range of $5 to $400 for one product—where $5 is the value 0 and $400 is the value 1 with $202.50 being the value 0.1).

In the above, the list is suggestive and include others but also noteworthy, certain traits are subjective while others may be more subjective. For example, a subjective trait will be emotional-based while others may be fact based. As part of current events, if a political situation occurs where the unique colors of a country's flag are being widely broadcasted (e.g. the yellow and blue colors of the Ukrainian flag) and are widely supported politically, a “mood” or suggestive level may arise temporarily based on such events. In the above, such two colors, seen more traditional would then become more subjective and will connect with emotions of the person, such colors may change how a person perceives and buys a bottle of wine.

The same way color is shown at FIG. 7 as part of the analysis the same “perception” additional descriptor for the product can be automated to recognize the automatically and quantify for bottle shape, bottle color, size of label on a bottle, the symmetrical v asymmetrical nature of the label, the shape of a label, the number of words, or the object detection. For example, as part of a “serious” label may be programmed that labels with fewer words printed tend to be more serious. Also, certain designs like castles would give “serious” quantification points. Once again, while this system is described in association with descriptors of wine, or on a wine bottle, the inventors contemplate this manual and/or automated process of additional quantification of descriptors linked with perception and other features to be useful in a subsequent step of the AI.

To the inventors, the use of RGB values in each pixel of an image are clustered using K-means to yield 50 unique RGB descriptors for each label. The use of hue property from HSV representations of colors in step 1 above allows for a map of 50 unique RGB descriptors to 24 color names (e.g. red, orange, chartreuse, etc.). Finally the saturation and value property of the HSV attribute are used to differentiate automatically between “light” or “vivid” or “dark” tones. Once again, this allows for descriptors to be added as “light-red” or “vivid-red” or even “dark-red” instead of a simple color. The inventor gives a weighted distribution for those with mostly dark and mostly white labels with minimal saturation and low value as grey

The recommendation module 211 as shown at FIG. 7 is part of the intelligence module 210 and allows for the recommendations to customers of the best and optimal product from the products 200 based on one or more of the effects. For example, as part of a computer interface or a virtual reality interface, the customers will look at certain products over others. Using HD factors and the genome 209 of the product looked at, or using cookies or other tools to secure information on the user, such choices are quickly associated with one of the HDs in the system which in turn will hunt and retrieve the proper products.

In some scenarios, previously known consumers will have generated explicit and implicit feedback. For example, as consumers view, select, review, purchase, and otherwise interact with wines, the activity may be recorded and associated with that consumer. In other scenarios, a new consumer will not have generated any explicit or implicit feedback. In those cases, additional third party data may also be available and used to supplement and/or generate the consumer profile. While the following list is not a fully comprehensive list, an example of consumer profile attributes are: age, gender, occupation, income, referrer, geolocation, device (browser/OS), product views, clickstream activity, purchase history, email activity, ratings, survey responses, personality type, activities, interests, and opinions. A consumer preference profile may contain the various wine packaging descriptors along with any consumer preference intensity values, and can be obtained in at least two ways.

In some scenarios, an existing consumer will have generated enough explicit and implicit feedback to calculate his/her preference. For example, as existing customers view, select, review, purchase and otherwise interact with wines, the activity is recorded, and their preference can be deduced directly from such activities. In other scenarios, a new consumer has not generated enough activities to calculate his/her preference. In those cases, this particular consumer is matched to other consumers in the database, and then his/her preference is estimated based on similar consumers. The similarity may be based on a combination of any available consumer profile and consumer behavior data. While the following list is not a fully comprehensive list, examples of possibly known consumer profile data for new consumers are: age, gender, geolocation, device (browser/operating system), income, etc.

Information relating to past orders of wine, wine browsed, rating/comments read or entered as to wine, different clicks or streaming, and web page currently being browsed. A customer can receive a gift of an expensive bottle. Surfing online, he/she will enter the name of the blend, the year, and even more precise information as the bottle is held in hand. That information can be used to associate preferences but if the user does not click, the information can be changed in category and the determination that the user only wants pricing can be entered into the database.

Information directly related to a wine can also be entered. For example the color, the varietal, the country, the region, the year, the primary color of label, the secondary color of label, the type of closing mechanism, the notion that a label has certain distinctive features, for example an animal, a castle, etc. In one contemplated embodiment, information is secured in multiple ways relating to a user. A personalized email message or a webpage in html format can then be generated using that information or a personalized recommendation product listing page or other virtual reality aspect can also be generated.

In addition to eye-tracking information technology use, what is contemplated is the use of touch features on computers, pads, and cell phones or other systems to enhance selection and use of the system. For example, in the dating area a left-right swiping system allows users to quickly provide data entry of favorite selections into a system. Using the same technology, one an email is sent with arranged bottles using the above technology, a user can be asked to swipe or touch portions of the screen of greater interest. For example, the bottles using this technology can be aligned from front to back and a user can simply swipe aside bottle designs is likes and those it does not as part of an interface part of a module. This system will help enter into a first module to enter into a database a plurality of input resulting from the swipe action relating to the label of the wine. In some embodiment, the second module can be used to help generate a user profile of a specific user of a device and not generally for the device as a whole.

As shown at FIG. 12, the crawling module 210 is designed to either user/read the client and user 600 either directly or indirectly via one of the numerous modes described above. As a default or additional information 601 the use of a default environmental and societal setting can be used as shown clearly at FIG. 12. For example, such a system on the week after a war has broken down in Ukraine can be set to an environmental setting 601 such as “concern” or “serious” which may be directly associated with one or more of the HDs part of the model and describing the different products 200. Often, advertising online or in the medias does not touch the right note. Comedians joked of how a hamburger cheerful add can be tone deaf after some very grave news hits the airwave. Seconds after announcing the passing of a Supreme Court justice, some strange add will play. This marketing and advertising and affinity pairing system, is designed to specially adjust the right advertisement to the right current events by pushing out and selecting the right add in the product 200 database after a demand is made. As part of the input parameter in the above example, instead of a user, the previous news segment is simply input.

Once a match is made (i.e. the news was dramatic, so a solemn product (advertisement or even wine) must be selected), then at phase 211, the AI either recommends an add to be played. In the prediction module 212, a person can query the system for the proper read. Very importantly, the prediction module includes an input 603 that is not a product but a new potential product or service. The inventors understand that before a new product is released, as part of marketing internal processes, or even at other stages of manufacturing or production, a person may desire to know how the artificial intelligence will perceive the new product which in turn will help the person selling and marketing anticipate what type of reaction the product will face in the marketplace. For example, a person may put the picture of the founder of a winery on the label thinking the public will perceived the product with kindness but in fact, data and experience may show such large facial images to be associated with “tradition” and “strength” instead of “kindness.” The prediction module 212 is also paired with the recommendation module 211 to help provide associative intelligence. Finally the analysis module 213 may be used to help return on the effectiveness of the system and give analysis information 213. One wine maker, who has seen sales drop may want to enquire as to why and wants data on how to better change and update for future sales.

The above describes generally and in precision a descriptor-based AI for use on and in relation with computerized affinity systems. Computer software, inside of hardware allows for the implementation of the above AI in a computer, on a website engine, in an App, as part of a new Virtual Reality world. But such new invention and system, once in existence also creates new associated methods of sales, of marketing, of data crawling when the AI is implemented.

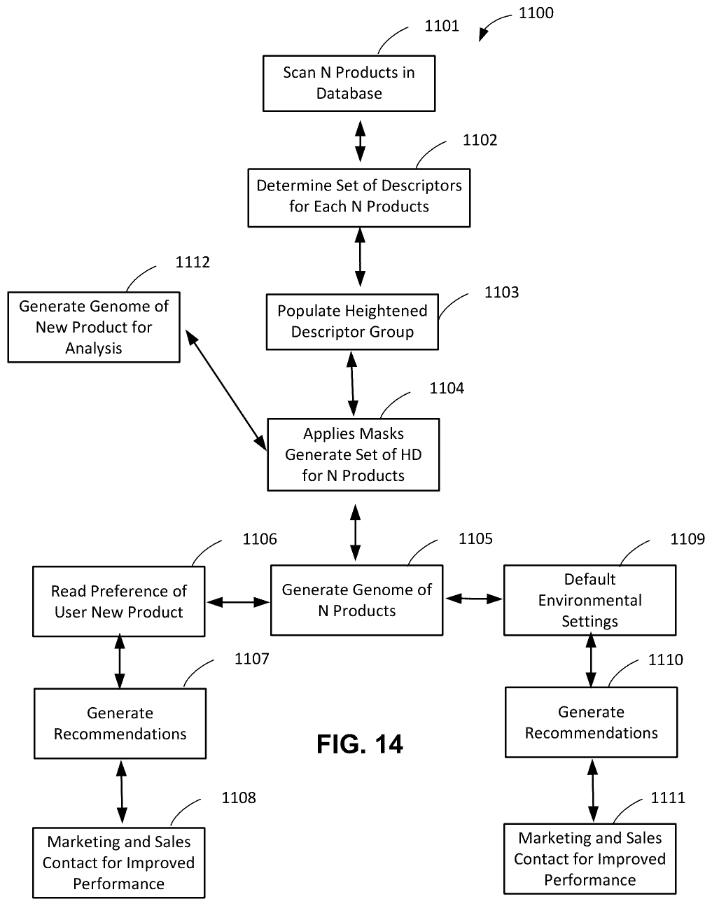

FIG. 14 shows as part of the method of sale 1100 how in a first step 1101, a number N of products is scanned into a database, in a second step 1101, a first determination of a set of descriptors is generated, then 1102, each of the N products is scanned or processed to populate a database in which each of the N products is given data as to each descriptor VD, FD, or DD 202, 203, and 204 for a total of L descriptors. At step 1103, an AI system 225 is populated with one of G masks each for a different heightened descriptor. Subsequently, the AI using database 201 applies 1104 each G masks to generate a HD value for each of the G masks and the F HD values. Next, the AI system 225 stores each HD as part of the product N genome 209.

The genome of each product 1105 can then be used in relations with a newly read product 1106 in order generate improved sales by either generating recommendations 1107 from the N products using a recommendation module 211. Such module can, for example display on a screen, an email, a screen or even via a virtual reality environment the recommendations to generate 1108 recommendations of sales and marketing. In an alternative method of recommendations, a default environmental setting can be used 1109 to help generate sales by connecting and displaying via the recommendation module 211 different products 200. This in turn results in recommendations 1110, and sales 1111. Finally at step 1112, a genome for a new product for analysis is given to the system to apply the masks of HD. The inventor teaches the value of the universe of products 200 and their respective genomes 1105 as useful feature.

The inventors hereafter have claimed a descriptor-based artificial intelligence (AI) for use on computerized affinity systems in a computer-implemented environment, the AI and associated system comprising: at least one network enabled server comprising a server processor with a server memory, the server processor being configured to hold an affinity system including a software for hosting an item database stored in the server memory, wherein the item database includes a plurality of entries, each for a plurality of items for sale to consumers and each of the plurality of items for sale being defined with a plurality of initial descriptors, and an artificial intelligence (AI) module to access the database, a plurality of personal computers each with at least a computer processor with a computer memory, a computer display connected to the computer processor, each for access to the network enabled server via the network, wherein the plurality of personal computers serve as local devices for access to the software remotely and the server serves as a remote device for hosting the software; wherein the AI module includes a first module for accessing the plurality of items in the database and reading all of the initial descriptors associated with each of the items, at least one mask for processing the initial descriptors for each of the items in the database and for generating a heightened descriptor for each of the items in the database, and a module for adding the heightened descriptor back to the database as part of the total set of descriptors for each of the items in the database; and a module for using the heightened descriptor of each of the items in the database for delivering to the plurality of personal computers via the network from the server optimized sales or marketing information linked with the affinity system based on the heightened descriptor.

In addition, the inventors also note that the invention also relates to the plurality of initial descriptors for each of the items in the database are taken from a set of visual descriptors, functional descriptors, and descriptive descriptors, and wherein the affinity system includes an extraction module for the automation of the visual descriptor extraction for each of the plurality of items in the database. Also, wherein the items in the database are either a product for consumer sale, a service for consumer use, or a joint product and service combination also for purchase by a consumer. Wherein the items in the database are bottle of wines, the visual descriptors are descriptors linked with the wine container or packaging and label, the functional descriptors are associated with the wine itself, and the descriptive descriptors can include grading subjective reviews of the wine. Wherein the extraction module for the automation of visual descriptors includes a label color extraction module for quantifying as part of the initial descriptors a set of colors linked with the label of each wine. Wherein the heightened descriptor is a perception descriptor selected from a ranged group scaling between two ends and described generally as: modern/traditional, gloomy/cheerful, crude/elegant, playful/serious, ordinary/unique, safe/dangerous, cheap/premium, plain/eye-catching, and boring/intriguing. Wherein the module for using the heightened descriptor of each of the items in the database for delivering to the plurality of personal computers via the network from the server optimized sales or marketing information linked with the affinity system based on the heightened descriptor, is selected from a group comprising of a recommendation module, a prediction module, or an analysis module. And wherein the AI further comprises a module for the creation of masks for processing the initial descriptors comprising a selection of a set of descriptors from the initial descriptors, a creation of a user survey for each of the set of selected descriptors, a use of coefficients of relevance for each of the selected descriptors, the collection and processing of the data from the survey for each of the set of descriptors and the creation of a range for each of the descriptors. Also wherein one created marks for each of the heightened descriptor is stored in the database and wherein the module for creation of masks for processing of the AI further includes a submodule for the analysis of outliers of items in the database which appears the heightened descriptor is not applicable and for creating a new initial descriptor for each of the items in the database to resolve the outlier or wherein at least one of the personal computers is selected from a group of: desktop computer, portable computer, tablet, web-enabled cellphone, virtual-reality headset, or web-enabled smart-watch each able to connect to the network and the server.

The surveys are often not used on each product 200. A hundred or so products 200 are run in the survey to help determine a spectrum as a training set for initial entry. This is then used to help generate HD scores when compared with the training set secured. In another embodiment, the use of typically two hundred or more for the training set surveys is contemplated.

Also claimed at the moment is a method to improve the sale of an item using a descriptor-based artificial intelligence (AI) in a computer-implemented environment comprising at least one server to hold a software for hosting an item database with o We typically use 200 or more for the training set surveys, but the way this is worded is probably a plurality of items each for sale to consumers being defined with a plurality of initial descriptors, and an AI module to access each items in the database and read the initial descriptors associated with each of the items and apply least one mask for processing the initial descriptors into a heightened descriptor for each of the items in the database, and a module for adding the heightened descriptor back to the database for each of the items and a module for using the heightened descriptor, the method including the steps of securing information regarding a client or user's desire associated with one or more heightened descriptor, searching and indexing the database for items having a high range value of the heightened descriptor secured from client or user, matching the client or user's desire with at least one item in the database, and use of a recommendation module to present to the client or user the items from the database matched.

Also other sub methods include further including the step of using a mask to generate each of the one or more heightened descriptor from the plurality of initial descriptors the heightened descriptors required for the search of searching and indexing the database, the step of creating a range value of the heightened descriptor after the step of using the masks to create the heightened descriptors from the initial descriptors for use by the step of search and indexing and for the matching step, wherein the initial descriptors for each of the items in the database are taken from a set of visual descriptors, functional descriptors, and descriptive descriptors, and wherein the method includes the preliminary step of extracting using automation of the visual descriptor for each of the plurality of items in the database or wherein the items in the database are either a product for consumer sale, a service for consumer use, or a joint product and service combination also for purchase by a consume and wherein the items in the database are bottle of wines, the visual descriptors are descriptors linked with the wine container or packaging and label, the functional descriptors are associated with the wine itself, and the descriptive descriptors can include grading subjective reviews of the wine. The same way, wherein the extraction step for the automation of visual descriptors includes a sub-step of using a label color extraction module for quantifying as part of the initial descriptors a set of colors linked with the label of each wine and wherein the desire is a perception descriptor selected from a ranged group scaling between two ends and described generally as: modern/traditional, gloomy/cheerful, crude/elegant, playful/serious, ordinary/unique, safe/dangerous, cheap/premium, plain/eye-catching, and boring/intriguing.

With the same logic, also claimed is a method to market an item using a descriptor-based artificial intelligence (AI) in a computer-implemented environment comprising at least one server to hold a software for hosting an item database with a plurality of items each for sale to consumers being defined with a plurality of initial descriptors, and an AI module to access each items in the database and read the initial descriptors associated with each of the items and apply least one mask for processing the initial descriptors into a heightened descriptor for each of the items in the database, and a module for adding the heightened descriptor back to the database for each of the items and a module for using the heightened descriptor, the method including the steps of: securing information regarding a client or user's desire associated with one or more heightened descriptor, searching and indexing the database for items having a high range value of the heightened descriptor secured from client or user; matching the client or user's desire with at least one item in the database, and use of a prediction module or an analysis module to provide the client with marketing information using the items from the database matched or conclusions derived therefrom.

As part of the online shopping experience, users can visit stores when computers or tablets (also other interfaces) can be used to help the system 1 as shown guide the user. As part of a digital virtual reality world, using a VR set, a person can access the system electronically as if the person was shopping. In one contemplated interface, a digital store is shown and emulates the live experience. In other contemplated experiences, the interface in VR emulates an online experience. In this process, a camera in the VR set measures the user's eye movement and focuses in eye-catching interest or other interest using the VR interface (e.g. pointing with a glove).

Therefore, while the presently-preferred form of the wine recommendation and wine label affinity system has been shown and described, and several modifications and alternatives discussed, persons skilled in this art will readily appreciate that various additional changes and modifications may be made without departing from the spirit of the invention, as defined and differentiated by the following claims.

1. An artificial intelligence (AI) for use on a virtual-reality (VR) affinity systems in a VR environment, the AI and associated system comprising:
at least one network enabled server comprising a server processor with a server memory, the server processor being configured to hold an affinity system including a software for hosting an item database stored in the server memory, wherein the item database includes a plurality of entries, each for a plurality of items for sale to consumers and each of the plurality of items for sale being defined with a plurality of initial descriptors, and an artificial intelligence (AI) module to access the database;
a plurality of virtual-reality headsets each able to connect to the network and the server each with at least a computer processor with a computer memory, a computer display connected to the computer processor, each for access to the network enabled server via the network, wherein the plurality VR headsets serve as local devices for access to the software remotely and the server serves as a remote device for hosting the software;
wherein the AI module includes a first module for accessing the plurality of items in the database and reading all of the initial descriptors associated with each of the items, at least one mask for processing the initial descriptors for each of the items in the database and for generating a heightened descriptor for each of the items in the database, and a module for adding the heightened descriptor back to the database as part of the total set of descriptors for each of the items in the database; and
a module for using the heightened descriptor of each of the items in the database for delivering to the plurality of VR headsets via the network from the server optimized sales or marketing information linked with the affinity system based on the heightened descriptor.

2. The artificial intelligence (AI) for use on a virtual-reality (VR) affinity systems in a VR environment of claim 1, wherein the plurality of initial descriptors for each of the items in the database are taken from a set of visual descriptors, functional descriptors, and descriptive descriptors, and wherein the affinity system includes an extraction module for the automation of the visual descriptor extraction for each of the plurality of items in the database.

3. The artificial intelligence (AI) for use on a virtual-reality (VR) affinity systems in a VR environment of claim 1, wherein the items in the database are either a product for consumer sale, a service for consumer use, or a joint product and service combination also for purchase by a consumer.

4. The artificial intelligence (AI) for use on a virtual-reality (VR) affinity systems in a VR environment of claim 2, wherein the items in the database are bottle of wines, the visual descriptors are descriptors linked with the wine container or packaging and label, the functional descriptors are associated with the wine itself, and the descriptive descriptors can include grading subjective reviews of the wine.

5. The artificial intelligence (AI) for use on a virtual-reality (VR) affinity systems in a VR environment of claim 4, wherein the extraction module for the automation of visual descriptors includes a label color extraction module for quantifying as part of the initial descriptors a set of colors linked with the label of each wine.

6. The artificial intelligence (AI) for use on a virtual-reality (VR) affinity systems in a VR environment of claim 5, wherein the heightened descriptor is a perception descriptor selected from a ranged group scaling between two ends and described generally as: modern/traditional, gloomy/cheerful, crude/elegant, playful/serious, ordinary/unique, safe/dangerous, cheap/premium, plain/eye-catching, and boring/intriguing.

7. The artificial intelligence (AI) for use on a virtual-reality (VR) affinity systems in a VR environment of claim 1, wherein the module for using the heightened descriptor of each of the items in the database for delivering to the plurality of personal computers via the network from the server optimized sales or marketing information linked with the affinity system based on the heightened descriptor, is selected from a group comprising of: a recommendation module, a prediction module, or an analysis module.

8. The artificial intelligence (AI) for use on a virtual-reality (VR) affinity systems in a VR environment of claim 1, wherein the AI further comprises a module for the creation of masks for processing the initial descriptors comprising a selection of descriptors from the initial descriptors, a creation of a user survey for some descriptors, and the determination of a baseline coefficients of relevance for each descriptors.

9. The artificial intelligence (AI) for use on a virtual-reality (VR) affinity systems in a VR environment of claim 8, wherein one created marks for each of the heightened descriptor is stored in the database.

10. The artificial intelligence (AI) for use on a virtual-reality (VR) affinity systems in a VR environment of claim 8, wherein the module for creation of masks for processing of the AI further includes a submodule for the analysis of outliers of items in the database which appears the heightened descriptor is not applicable and for creating a new initial descriptor for each of the items in the database to resolve the outlier.

11. A method to improve the sale of an item using a descriptor-based artificial intelligence (AI) for use on a virtual-reality (VR) environment comprising at least one server to hold a software for hosting an item database with a plurality of items each for sale to consumers being defined with a plurality of initial descriptors, and an AI module to access each items in the database and read the initial descriptors associated with each of the items and apply least one mask for processing the initial descriptors into a heightened descriptor for each of the items in the database, and a module for adding the heightened descriptor back to the database for each of the items and a module for using the heightened descriptor, the method including the steps of:
securing information regarding a client or user's desire associated with one or more heightened descriptor via an eye-tracking system in a VR headset;
searching and indexing the database for items having a high range value of the heightened descriptor secured from client or user;
matching the client or user's desire with at least one item in the database; and
use of a recommendation module to present to the client or user the items from the database matched.

12. The method of claim 11, further including the step of using a mask to generate each of the one or more heightened descriptor from the plurality of initial descriptors the heightened descriptors required for the search of searching and indexing the database.

13. The method of claim 12, further including the step of creating a range value of the heightened descriptor after the step of using the masks to create the heightened descriptors from the initial descriptors for use by the step of search and indexing and for the matching step.

14. The method of claim 13, wherein the initial descriptors for each of the items in the database are taken from a set of visual descriptors, functional descriptors, and descriptive descriptors, and wherein the method includes the preliminary step of extracting using automation of the visual descriptor for each of the plurality of items in the database.

15. The method of claim 12, wherein the items in the database are either a product for consumer sale, a service for consumer use, or a joint product and service combination also for purchase by a consumer in a VR environment.

16. The method of claim 11, wherein the items in the database are bottle of wines shown in a VR environment, the visual descriptors are descriptors linked with the wine container or packaging and label, the functional descriptors are associated with the wine itself, and the descriptive descriptors can include grading subjective reviews of the wine.

17. The method of claim 15, wherein the extraction step for the automation of visual descriptors includes a sub-step of using a label color extraction module for quantifying as part of the initial descriptors a set of colors linked with the label of each wine.

18. The method of claim 17, wherein the desire is a perception descriptor selected from a ranged group scaling between two ends and described generally as: modern/traditional, gloomy/cheerful, crude/elegant, playful/serious, ordinary/unique, safe/dangerous, cheap/premium, plain/eye-catching, and boring/intriguing.

19. A method to market an item using a descriptor-based artificial intelligence (AI) in a virtual-reality environment comprising at least one server to hold a software for hosting an item database with a plurality of items each for sale to consumers being defined with a plurality of initial descriptors, and an AI module to access each items in the database and read the initial descriptors associated with each of the items and apply least one mask for processing the initial descriptors into a heightened descriptor for each of the items in the database, and a module for adding the heightened descriptor back to the database for each of the items and a module for using the heightened descriptor, the method including the steps of:
securing information regarding a client or user's desire associated with one or more heightened descriptor;
searching and indexing the database for items having a high range value of the heightened descriptor secured from client or user;
matching the client or user's desire with at least one item in the database; and
use of a prediction module or an analysis module to provide the client with marketing information using the items from the database matched or conclusions derived therefrom.

20. The method of claim 19, further including the step of using a mask to generate each of the one or more heightened descriptor from the plurality of initial descriptors the heightened descriptors required for the search of searching and indexing the database.

21. The method of claim 20, further including the step of creating a range value of the heightened descriptor after the step of using the masks to create the heightened descriptors from the initial descriptors for use by the step of search and indexing and for the matching step.

22. The method of claim 21, wherein the initial descriptors for each of the items in the database are taken from a set of visual descriptors, functional descriptors, and descriptive descriptors, and wherein the method includes the preliminary step of extracting using automation of the visual descriptor for each of the plurality of items in the database.

23. The method of claim 22, wherein the items in the database are either a product for consumer sale, a service for consumer use, or a joint product and service combination also for purchase by a consumer.

24. The method of claim 19, wherein the items in the database are bottle of wines, the visual descriptors are descriptors linked with the wine container or packaging and label, the functional descriptors are associated with the wine itself, and the descriptive descriptors can include grading subjective reviews of the wine.

25. The method of claim 22, wherein the extraction step for the automation of visual descriptors includes a sub-step of using a label color extraction module for quantifying as part of the initial descriptors a set of colors linked with the label of each wine for display in a VR environment.

26. The method of claim 25, wherein the desire is a perception descriptor selected from a ranged group scaling between two ends and described generally as: modern/traditional, gloomy/cheerful, crude/elegant, playful/serious, ordinary/unique, safe/dangerous, cheap/premium, plain/eye-catching, and boring/intriguing.
